(19) United States
(12) Patent Application Publication
(10) Pub. No.: US 2026/0178003 A1
(43) Pub. Date: Jun. 25, 2026

(54) SYSTEMS AND METHODS FOR FORECASTING VARIABLE IRRIGATION ELECTRICITY NEEDS AND CURTAILING AGRICULTURAL IRRIGATION

(71) Applicant: Inventus Holdings, LLC, Juno Beach, FL (US)

(72) Inventors: Duc P.H. Nguyen, West Palm Beach, FL (US); William G. Kemmerer, West Palm Beach, FL (US); Timothy W. See, West Palm Beach, FL (US); Lester J. Aponte-Cepeda, Lake Worth, FL (US); Rachana Vidhi, Palm Beach Gardens, FL (US)

(21) Appl. No.: 18/987,775

(22) Filed: Dec. 19, 2024

(51) Int. Cl. G05B 19/042; G06N 20/20

(52) U.S. Cl. CPC G05B 19/042; G06N 20/20; G05B 2219/2625

(57) ABSTRACT

In some embodiments, apparatuses and methods are provided herein useful for use in forecasting electrical load needed for a region including a computer and a trained machine learning model. The computer including a control circuit. In some embodiments, the trained machine learning model is configured to: receive forecast environmental data corresponding to the region; determine a day-ahead forecast electrical load needed for the irrigation (such as agricultural irrigation) in the region; transmit a communication configured to cause the day-ahead forecast electrical load needed to be displayed to a user; determine a difference between the day-ahead forecast electrical load needed and an actual electrical load used for the irrigation in the region on a forecast day; obtain actual environmental data corresponding to the region for the forecast day; and apply the difference and the actual environmental data to the random forest algorithm to adjust the trained machine learning model.

### TECHNICAL FIELD

This invention relates generally to electricity consumption used for agricultural irrigation.

### BACKGROUND

Electricity is generated from a variety of sources, including fossil fuels, nuclear, and renewable energy. Typically, electricity generators sell their generated electricity via commodity market exchanges, such as power exchanges. In these exchanges, electricity traders buy and sell options based on their forecast of the amount of energy needed for their respective customers or consumers. Power exchanges provide a short-term spot market such as a day-ahead market and an intraday market, where power is traded for either the upcoming or for the current day, respectively. These exchanges are used to buy and sell power on short notice to meet changing demand to level out forecast deviations (or shortfalls) in both consumption and production. A large shortfall resulting from an inaccurate energy consumption forecast can cause an electricity provider to need to compensate for the shortfall by buying energy at a prevailing market price in the intraday market, which is generally more expensive than it would have been if purchased in the day-ahead market.

Agricultural producers are one of the typical consumers served by the electricity providers. Agricultural producers need electrical energy supply to power their irrigation systems for their crops' needs, e.g., electricity is needed to power irrigation pumps. Electricity providers typically allocate power based on their overall customers' historical power consumption. However, the irrigation needs of an agricultural consumer can vary greatly from day to day based on many factors, such as changes in environmental conditions and crop characteristics. This can lead to inconsistent agricultural irrigation activities and inconsistent electricity consumption. As a result, inconsistent agricultural irrigation can lead to shortfalls in electricity purchased by electricity providers in the day-ahead market.

### BRIEF DESCRIPTION OF DRAWINGS

Disclosed herein are embodiments of systems, apparatuses and methods for use in forecasting electrical load needed for a region and/or for minimizing the risks associated with shortfalls in purchased electricity. This description includes drawings, wherein:

FIG. 1 is a simplified power distribution diagram in accordance with some embodiments;

FIG. 2 is a simplified block diagram of a power distributor system using a trained machine learning model to forecast electricity load or consumption including forecasting irrigation electrical load in a region in accordance with some embodiments, and/or to provide electrical load curtailment options when a shortfall occurs in accordance with some embodiments;

FIG. 3 is a flow diagram of an exemplary random forest algorithm of a trained machine learning model in accordance with some embodiments;

FIG. 4 illustrates a plurality of features or variables in order of importance used by an exemplary random forest algorithm in accordance with some embodiments;

FIG. 5 is a simplified block diagram of an exemplary load shedding or curtailment use case of forecasting electrical load in irrigation in accordance with some embodiments;

FIG. 6 is a functional block diagram of one embodiment of the exemplary system of FIG. 2 in accordance with some embodiments;

FIG. 7 is a flow diagram of an exemplary method for use in forecasting irrigation electrical load needed for a region in accordance with some embodiments;

FIG. 8 is a flow diagram of an exemplary method for energy management including curtailment of electrical load needed for irrigation, for example, when an electrical shortfall is determined to occur, in accordance with some embodiments; and

FIG. 9 is an exemplary system for use in implementing methods, techniques, devices, apparatuses, systems, servers, sources and for use in forecasting electrical load needed for a region and/or curtailment of electrical load in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments,” “an implementation,” “some implementations,” “some applications”, or similar language means that a particular feature, structure, or characteristic described in connection with the embodiment is included in at least one embodiment of the invention. Thus, appearances of the phrases “in one embodiment,” “in an embodiment,” “in some embodiments,” “in some implementations,” and similar language throughout this specification may, but do not necessarily, all refer to the same embodiment.

Generally speaking, pursuant to various embodiments, systems, apparatuses and methods are provided herein for use in forecasting electrical load needed for a region. Additionally, in some embodiments, this may improve day-ahead power purchase forecasts for utilities serving significant farming irrigation loads. In some embodiments, a system for use in forecasting electrical load needed for a region includes a computer including a control circuit, a communication circuit, and a trained machine learning model stored on a non-transitory storage medium and executable by the control circuit. The trained machine learning model is trained using historical environmental data and historical irrigation load data. When executed, the trained machine learning model may receive, via the communication circuit, forecast environmental data corresponding to the region, the region including a plurality of properties that will use electrical load for irrigation of plant life in the region, the electrical load due to an operation of at least an electrical pump of irrigation equipment at each of the plurality of properties. Alternatively or in addition, the trained machine learning model may determine, using a random forest algorithm, a day-ahead forecast electrical load needed for the irrigation in the region. Alternatively or in addition, the trained machine learning model may transmit a communication to cause the day-ahead forecast electrical load needed for the irrigation in the region to be displayed to a user. Alternatively or in addition, the trained machine learning model may determine a difference between the day-ahead forecast electrical load needed for the irrigation in the region and an actual electrical load used for the irrigation in the region on a forecast day. Alternatively or in addition, the trained machine learning model may obtain actual environmental data corresponding to the region for the forecast day. Alternatively or in addition, the trained machine learning model may apply the difference and the actual environmental data to the random forest algorithm to adjust the trained machine learning model for future forecasts of the day-ahead forecast electrical load needed for the irrigation in the region.

In some embodiment, a method for use in forecasting electrical load needs including electrical irrigation needs for a region includes receiving, via a communication circuit by a trained machine learning model stored on a non-transitory storage medium and executable by a control circuit, forecast environmental data corresponding to a region, the region including a plurality of properties that will use electrical load for irrigation of plant life in the region, the electrical load due to an operation of at least an electrical pump of irrigation equipment at each of the plurality of properties, wherein a computer includes the control circuit and the communication circuit. The trained machine learning model is trained using historical environmental data and historical irrigation load data. Alternatively or in addition, the method may include determining, using a random forest algorithm, a day-ahead forecast electrical load needed for the irrigation in the region. Alternatively or in addition, the method may include transmitting a communication, the communication configured to cause the day-ahead forecast electrical load needed for the irrigation in the region to be displayed to a user. Alternatively or in addition, the method may include determining a difference between the day-ahead forecast electrical load needed for the irrigation in the region and an actual electrical load used for the irrigation in the region on a forecast day. Alternatively or in addition, the method may include obtaining actual environmental data corresponding to the region for the forecast day. Alternatively or in addition, the method may include applying the difference and the actual environmental data to the random forest algorithm to adjust the trained machine learning model for future forecasts of the day-ahead forecast electrical load needed for the irrigation in the region.

For example, a first computer may periodically execute a trained machine learning model to determine for a particular region whether a power distributor's protection against loss in the day-ahead market for a particular day was met and/or at least was within a desired range of accuracy of that day's actual electricity consumption. In some embodiments, after a determination that the protection against loss resulted in a shortfall and/or resulted in the power distributor buying additional electricity load at that day's prevailing market price, the trained machine learning model determines the difference between the protection against loss made in the day-ahead market and the actual electricity consumption (the difference is also referred to as forecasting error). After determining the difference, the trained machine learning model performs a self-update or improvement by incorporating the difference when it is determining the forecasted electricity load for the subsequent day-ahead electricity consumption for the same region. In addition to the difference, the trained machine learning may additionally use one or more variables associated with the climate associated with the region, the characteristics of the crops planted in the region, the irrigation devices' watering efficiencies used in the region, and/or the irrigation field management practices in the region to determine the forecasted electricity load for the subsequent day-ahead electricity consumption. In some embodiments, the trained machine learning model may continually perform self-improvement until the desired range of accuracy is achieved.

In some embodiments, the trained machine learning model transmits data corresponding to the forecasted electricity load for the subsequent day-ahead electricity consumption to an electronic device (e.g., a computer, such as a server, a laptop, a smartphone, a mobile handheld electronic device, and/or any electronic device portable or standalone) associated with a user. In some embodiments, the user may then use the forecasted electricity load for the subsequent day-ahead electricity consumption to buy and/or sell options at the power exchange as a protection against loss in the day-ahead market.

In some embodiments, after a determination that a shortfall is forecasted in the available electrical load for the region, the first computer and/or another computer may perform mitigation options to avoid buying additional electricity load at a prevailing market price to make up for the shortfall. In some embodiments, the trained machine learning model determines one or more adjustments to irrigation at one or more properties in the region. Alternatively, or in addition, after determining the one or more adjustments, the trained machine learning model may determine whether each property has opted in or not for the adjustments. That is, if the property has opted in, the trained machine learning model may automatically transmit a control signal to an irrigation control device associated with the property causing the irrigation to be adjusted to mitigate the shortfall. The one or more adjustments may cause corresponding irrigation devices to deviate from their scheduled operation. In some embodiments, if the property has not opted-in, the trained machine learning model sends a control signal to a user interface associated with the property, causing the user interface to present the one or more adjustments to a user. In some embodiments, when the user chose to opt-in, the irrigation control device may implement the adjustments, e.g., by modifying or interrupting scheduled irrigation and/or removing power to the irrigation control device. In some embodiments, when the user chose to not opt-in, the first computer may receive a signal corresponding to the user's decision to not opt-in. In such embodiments, the first computer may automatically transmit a control signal to a computer associated with the power exchange to buy additional electrical load to compensate for the shortfall. Alternatively or in addition, the user who chose to not opt-in may then be charged for the additional electrical load.

The following description is not to be taken in a limiting sense, but is made merely for the purpose of describing the general principles of exemplary embodiments. Reference throughout this specification to “one embodiment,” “an embodiment,” “some embodiments,” “an implementation,” “some implementations,” “some applications”, or similar language means that a particular feature, structure, or characteristic described in connection with the embodiment is included in at least one embodiment of the invention. Thus, appearances of the phrases “in one embodiment,” “in an embodiment,” “in some embodiments,” “in some implementations,” and similar language throughout this specification may, but do not necessarily, all refer to the same embodiment.

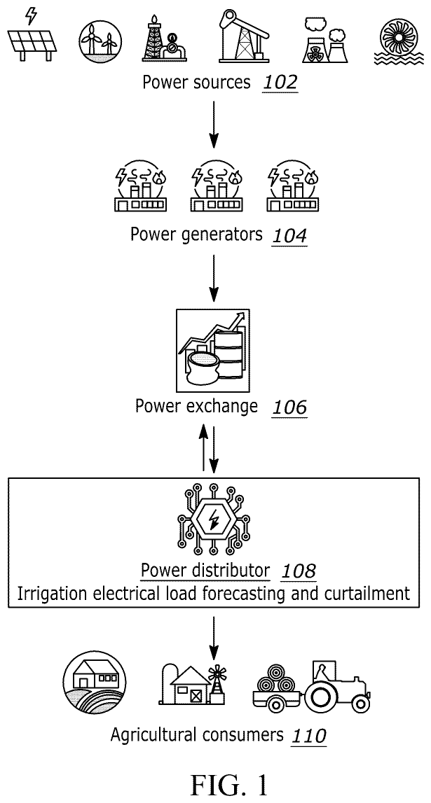

FIG. 1 is a simplified power distribution diagram. For example, there are a number of possible electrical power sources 102 including solar energy sources, wind energy sources, natural gas energy sources, petroleum or crude oil energy sources, nuclear energy sources, and/or hydroelectric energy sources, to name a few. In some embodiments, one or more power generators 104 may produce electricity using one or more combinations of these power sources 102. The power generators 104 may sell the electricity it produces in a wholesale electricity market, such as a power exchange 106. The power exchange 106 is a system enabling purchases (through bids to buy) and sales (through offers to sell). Bids and offers use supply and demand principles to set the price. As a market participant, a power distributor 108 may buy electricity in the power exchange 106 based on a forecasted electricity load needed for a region. Alternatively or in addition, the power distributor 108 may buy electricity in the power exchange 106 as a protection against loss in circumstances that there is a shortfall in the forecasted electricity load. Alternatively or in addition, the power distributor 108 may sell electricity it had previously bought when there is a surplus in the forecasted electricity load. In some embodiments, a power distributor 108 may provide the electricity it has purchased to its customers or consumers in a region. For example, a region may include a state, one or more cities or areas in the state, and/or one or more states in the country. In some embodiments, the power distributor 108 provides electricity to one or more agricultural consumers 110 in the region.

In an illustrative non-limiting example, the power distributor 108 may buy electricity in the power exchange 106 based on a forecasted electricity load or consumption by its customers including its agricultural consumers 110 at a given time and/or day in the week. However, the forecasted electricity load or consumption may be inaccurate due to variable or unusual weather occurring in the region for that particular season (e.g., unusually wet or dry season) causing unusual or unexpected increases or decreases in the actual electricity load or consumption for the region despite what was forecast. Further, the forecasted electricity load or consumption may be inaccurate due to one or more agricultural consumers 110 changing and harvesting the crops they planted for the season. An ordinary person skilled in the art would understand that there are other examples not mentioned herein that may cause the electricity load or consumption for the region to vary relative to the prevailing historical data.

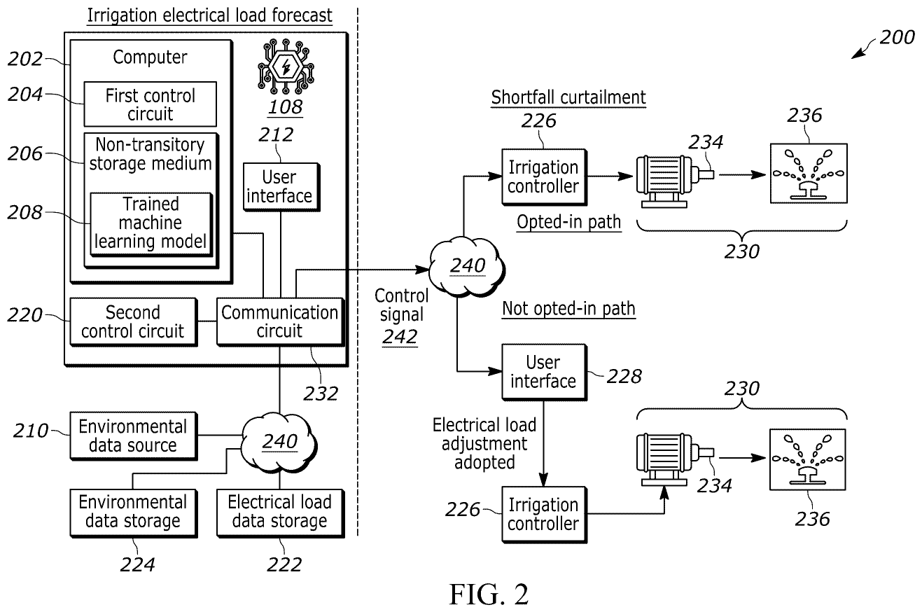

FIG. 2 is a simplified block diagram of a power distributor system 200 using a trained machine learning model to forecast electricity load or consumption including forecast irrigation electrical load in a region and curtailing/mitigating options when a shortfall occurs in accordance with some embodiments. For example, a computer 202 associated with the power distributor 108 may include a first control circuit 204, and a non-transitory storage medium 206 such as a memory. The computer 202 may be implemented as a server computer, a cloud-based computer, a desktop computer, and/or a mobile computer. In some embodiments, the computer 202 is associated with the power distributor 108 in that it is the computer owned or leased and controlled by the power distributor 108 or could be implemented as a cloud-based server accessible by the power distributor 108 within a cloud-based computing system. In some embodiments, the first control circuit 204 of the computer 202 comprises one or more processors capable of processing electronic data and/or any memory devices for storing and processing data according to instructions given to it in a variable program. In some embodiments, the power distributor 108 includes a second control circuit 220 that can similarly be implemented as part of a computer having a non-transitory storage medium storage such as a memory to store and execute computer instructions. In some embodiments, the second control circuit 220 is separate and distinct from the first control circuit 204. In some embodiments, the first control circuit 204 and the second control circuit 220 may be one and the same.

In some embodiments, the non-transitory storage medium 206 may include one or more memories (e.g., cloud or network storage devices, hard drives, solid state drives, and/or any electronic devices capable of storing electronic data accessible and/or executable by the computer 202, the first control circuit 204, and/or the second control circuit 220. In some embodiments, a trained machine learning model 208 may be stored in a non-transitory storage medium 206 and executable by the first control circuit 204, and/or the second control circuit 220. In some embodiments, the power distributor 108 system includes a communication circuit 232 used for internal and/or external communications. For example, the communication circuit 232 can communicate over any wired and/or wireless communication medium with the computer 202 and the second control circuit 220 and external device via a computer network 240.

Machine Learning Model to Forecast Electrical Load Needed for Irrigation

In some embodiments, the machine learning model 208 is trained to forecast the electrical load needed for irrigation in the region. In some embodiments, the machine learning model 208 is trained with historical environmental data obtained from an environment data storage 224 and with corresponding irrigation electrical load data obtained from an electrical irrigation data storage 222. These data storages 222 and 224 may be any database or memory configured to store and provide the specified data. When executed, the trained machine learning model 208 may receive, via the communication circuit 232, forecast environmental data corresponding to the region, e.g., from an environmental data source 210 such as a meteorological or MET station, such as a Midwest Climate Watch Meteorological (MRCC) station. In some embodiments, the environmental data source 210 provides one or more of the following forecast environment data: evapotranspiration, temperature, rainfall, atmospheric pressure, relative humidity, wind speed, dew point, and temperature.

The region may include a plurality of properties (e.g., farms) that will use electrical load for irrigation of plant life such as agricultural crops in the region. For example, a plant life may include soybean crop and/or corn crops, to name a few. In some embodiments, the electrical load needed may be due to an operation of irrigation equipment 230 (e.g., an electrical pump 234, a water valve 236 or sprinkler, to name a few) at each of the plurality of properties. Alternatively or in addition, the trained machine learning model 208 may determine a day-ahead forecast electrical load needed for the irrigation in the region (e.g., needed for agricultural irrigation in the region). In some embodiments, the trained machine learning model 208 uses a random forest algorithm to determine the forecast electric load needed for the region.

Alternatively or in addition, the trained machine learning model 208 may transmit a communication to cause the day-ahead forecast electrical load needed for the irrigation in the region to be displayed to a user of the power distributor (e.g., displayed at a user interface 212, such as a display or an application operable on an electronic device). For example, the user may receive a notification, an alert message, and/or an email via an electronic device associated with the user. In some embodiments, a user can use the day-ahead forecast of the electrical load needed for irrigation in the purchasing of electricity in a day-ahead market of a power exchange 106. It is understood that the user interface 212 can be implemented as part of the computer 202 or be in communication with the computer 202, either directly or via the communication circuit 232 and the computer network 240.

Alternatively or in addition, in some embodiments, feedback may be provided back to the trained machine learning model 208 for it to automatically retrain and/or adjust itself to improve future determinations. For example, in some embodiments, the trained machine learning model 208 may determine a difference between the day-ahead forecast electrical load needed for the irrigation in the region and an actual electrical load (e.g., accessed from and/or provided by one or more databases such as the electrical load data storage 222) used for the irrigation in the region on a forecast day. Alternatively or in addition, the trained machine learning model 208 may obtain actual environmental data corresponding to the region for the forecast day (e.g., accessed from and/or provided by one or more databases such as the environmental data storage 224 and/or from the environmental data source 210). Alternatively or in addition, the trained machine learning model 208 may determine and apply a difference between the forecast and actual electrical load for irrigation and the actual environmental data to the random forest algorithm for additional data points to adjust the trained machine learning model 208 for future forecasts of the day-ahead forecast electrical load needed for the irrigation in the region.

In some embodiments, the trained machine learning model 208 may automatically determine if it is to be retrained with new data when the difference between the day-ahead forecast of the electrical load needed for the irrigation in the region and the actual electrical load used for irrigation in the region on the forecast day is continuously greater than a pre-set threshold over a period of time. In some embodiments, depending on the utility tolerance to market spreads, the pre-set thresholds can be adjusted accordingly in the trained machine learning model. For example, one or more pre-set thresholds can be input to the trained machine learning model. In some embodiments, when the trained machine learning model determines that its forecasted electrical load for irrigation is continuously observed as having forecasting errors between 5 to 10%, the trained machine learning model 208 may perform model tuning and retraining. In some embodiments, the first control circuit 204 executes the adjusted trained machine learning model 208 to determine, using the random forest algorithm, a subsequent day-ahead forecast of electrical load needed for irrigation in the region.

### Mitigation Option During a Shortfall

In some embodiments, the second control circuit 220 may determine that a shortfall in an available electrical load for the region will likely occur. In some embodiments, the determination that a shortfall is likely to occur may be made at any point after the initial forecast of the electrical load needed for irrigation. For example, in some embodiments, the determination that a shortfall will occur can happen after the purchase of electricity in the day-ahead power market and prior to the start of the day of electrical usage. And in some embodiments, the determination that a shortfall will occur is made after the start of electrical load usage during the period of usage. For example, based on the electrical load usage by customers during the given day, it can be determined that usage will exceed the electricity purchased and additional electricity will need to be purchased in the real-time power market at a higher rate. In some embodiments, the second control circuit 220 determines that the shortfall is likely to occur, and in other embodiments, a different computer or control circuit makes this determination and provides the second control circuit 220 with the determination and estimate of the amount the electrical load will be exceeded. The algorithm (e.g., the trained machine learning model 208) leverages load forecasts to determine if a shortfall will occur. For example, when Day-Ahead power is purchased, the utility relies on forecasts that are twenty-four hours away from actual load. If demand is underestimated due to load forecast error, then a shortfall will occur. In some embodiments, updated or refreshed load forecasts become more accurate as the utility approaches the actual usage hours, such that the trained machine learning model 208 can calculate the amount of shortfall. In some embodiments, the trained machine learning model 208 may continuously monitor the accuracy of its forecast until the actual forecasted hour occurs.

In the event of a shortfall, some embodiments provide methods to curtail the electrical load due to irrigation to mitigate the effect of the shortfall and/or limit the amount of electricity that will need to be purchased at a higher rate in the real-time power market. In some embodiments, the second control circuit 220 determines an adjustment to irrigation at one or more properties in the region. In some embodiments, a customer of the power distributor 108 can be provided the option to opt-in to automatic adjustments, or not opt-in to automatic adjustments.

### Property Opted-In

Alternatively or in addition to, the second control circuit 220 may determine, for a first property, an adjustment to irrigation at the first property. For example, a first property may include an agricultural farm (e.g., soybean, corn, to name a few). Alternatively or in addition to, the second control circuit 220 may cause, in an event the first property has previously opted in for automatic irrigation adjustments, a control signal to be transmitted to an irrigation control device at the first property to cause the adjustment to be made to change the electrical load usage for the irrigation at the first property. In some embodiments, adjustment of irrigation load is determined by calculating the amount of load required to be adjusted along with the location of where that load needs to be adjusted. For example, first and second properties may both offer an equal amount of load that can be adjusted, and the algorithm may determine which property to adjust based on the geographical location of the property in relation to where load growth is occurring for the utility. For example, in such case, the load may be adjusted for the second property and not the first property if it is determined that there is a load growth at the second property. In some embodiments, the irrigation control device can be one or more of an irrigation controller 226, an electrical pump 234, and a water valve 236. For example, as illustrated in the embodiments of FIG. 2 (OPTED-IN PATH), a control signal 242 is communicated from the second control circuit 220 via the communication circuit 232 to the irrigation controller 226 which is controlling the operation of the electrical pump 234 and the water valve 236, the control signal 242 causing an alteration in the irrigation to reduce the electrical load. In some embodiments, the control signal 242 is sent to the electrical pump 234 to reduce the electrical load. And in other embodiments, the control signal 242 may be sent to the water valve 236 to reduce the electrical load. In some embodiments, the control signal 242 is configured to cause the adjustment to change the electrical load usage, the change comprises a change in an irrigation schedule of the first property (e.g., canceling of scheduled irrigation or shortening a run time of scheduled irrigation), an interruption of the irrigation schedule of the first property (e.g., overriding any scheduled irrigation), and/or a removal of electrical power to (or turning off the operation of) the irrigation control device (such as to the irrigation controller 226, the electrical pump 234 and/or the water valve 236) of the first property.

### Property Not Opted-In

Alternatively or in addition to, the second control circuit 220 may cause, in an event the first property has not previously opted in to the automatic irrigation adjustments, the control signal 242 to be transmitted to a user interface 228 (e.g., a smartphone, a laptop, and/or any electronic device capable of receiving signal and/or displaying messages, notifications, and/or indications associated with the control signal) associated with the first property and to cause the user interface 228 to present the adjustment to the user and allow the user to accept the adjustment or not. For example, the adjustment may be a recommendation to alter the scheduled irrigation of the first property in response to the determined shortfall (e.g., the forecasted day-ahead electrical load is projected to surpass the available electrical load for the first property). In some embodiments, the adjustment may cause the change in the electrical load usage for the irrigation at the first property if adopted. For example, the adjustment, if adopted, will modify the operation of an irrigation control device, such as the irrigation controller 226, the electrical pump 234 and the water valve 236 in accordance with the available electrical load to avoid a shortfall. In some embodiments, the user interface 228 displays the adjustment and allows the customer to make a selection to adopt or reject the adjustment. Alternatively or in addition, the second control circuit 220 may determine whether the user adopted the adjustment at the first property. For example, when the user interface 228 presents the adjustment to the user, the user is also prompted whether the adjustment will be adopted and signaling is sent back to the second control circuit 220.

In some embodiments, if the customer adopts the adjustment, the adjustment is caused to occur. For example, the control signal 242 is configured to be passed to the appropriate irrigation control device (e.g., irrigation controller 226, electrical pump 234 and water valve 236). For example, as illustrated in the embodiments of FIG. 2 (NOT OPTED-IN PATH), the control signal 242 is communicated to the user interface 228 . . . irrigation controller 226 which is controlling the operation of the electrical pump 234 and the water valve 236, the control signal 242 causing an alteration in the irrigation to reduce the electrical load.

In some embodiments, the second control circuit 220 may determine, in an event it is determined that a shortfall in an available electrical load for the region will likely occur, an adjustment to irrigation at a first property. Alternatively or in addition to, the second control circuit 220 may cause, in an event the first property has not previously opted in to automatic irrigation adjustments, a control signal to be transmitted to the user interface 228 associated with the first property and to cause the user interface 228 to present the adjustment to a user. In some embodiments, the adjustment will cause the change in electrical load usage for the irrigation at the first property if adopted.

In some embodiments, if a user or customer does not adopt the proposed adjustment, the customer may be charged an additional fee for a portion of the electrical load that will result in the shortfall.

### Trained Machine Learning Model

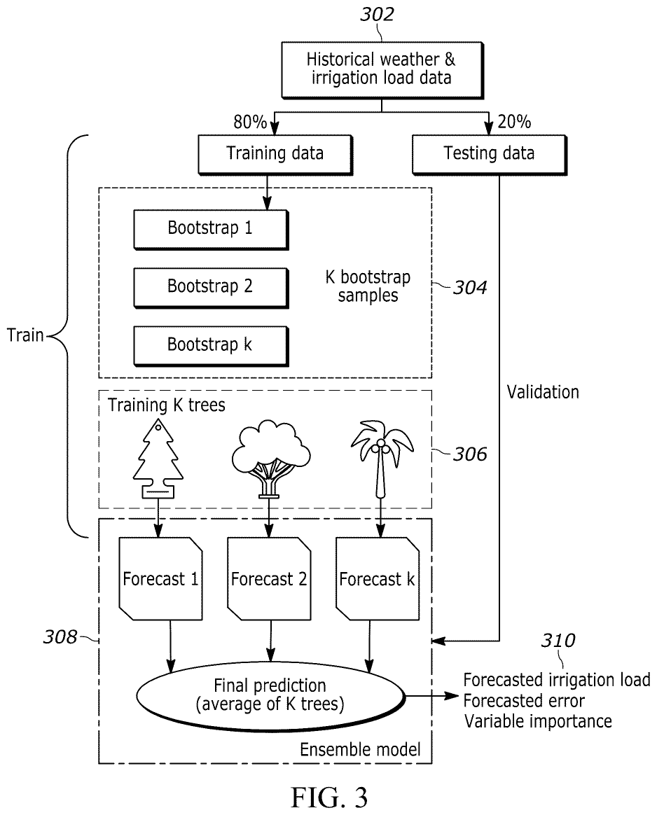

FIG. 3 shows a flow diagram of an exemplary random forest algorithm that can be used in implementing a trained machine learning model 208 in accordance with some embodiments. A random forest algorithm grows and combines multiple decision trees to create a forest that forecasts electrical load needs of a region and/or may improve day-ahead power purchase forecasts for utilities serving significant farming irrigation loads. For example, at 304, the random forest algorithm may perform row sampling and feature sampling from the dataset 302 (e.g., historical weather data and the corresponding historical irrigation load data) to form sample datasets for every model. At 306, each trained machine learning model is trained on each sample dataset independently. At 308, the output from each training tree (a forecast of the electrical load for irrigation) is aggregated to determine the final prediction. At 310, the forecasted irrigation electrical load, the forecasted error, and/or variable importance are output for display to and use by users of the power distributor 108. In some embodiments, 80% of the dataset 302 is used for training while 20% of the dataset 302 is used for validation. In some embodiments, the dataset 302 may include characteristics of the crops farmed or planted, time of use (e.g., what time and/or where the crops are in their growth cycle, to name a few) to assist in identifying when the crops need more water (hence, more electricity), geographical crops density, and/or the supplying electrical utility location. In some embodiments, the dataset 302 may include regional temperature, rainfall, atmospheric pressure, dew point, relative humidity, and/or wind speed. In some embodiments, the selection of the dataset 302 may include data that is associated with “the day and/or time the farmer irrigates given the weather variables and/or crop characteristics.” In some embodiments, the trained machine learning model 208 is trained to record forecasting error and/or the observed data into its training set. For example, the trained machine learning model 208 is trained with dataset 302. Alternatively or in addition to, the difference between the day-ahead forecast of the electrical load needed for the irrigation in the region and an actual electrical load used for irrigation in the region on a forecast day, and the actual environmental data may be included in a subsequent training dataset 302 used to retrain the trained machine learning model 208.

In some embodiments, the trained machine learning model 208 tests the predicted irrigation electrical load with the actual irrigation electrical load and records the difference (e.g., forecasting errors). Alternatively or in addition, the trained machine learning model 208 adds the new irrigation load and the forecasting error back into the model to improve future prediction. In some embodiments, the random forest model utilizes irrigation/energy/meteorology domain knowledge specifically in weather pattern impacts on crops' water demand and applies observation of consumers' behavioral response to weather patterns and optimal irrigation practices. For example, the training data is using specific energy consumption from utilities that primarily provide load services to farmers in a particular region and weather data obtained from both open sources as well as in-house internal weather measuring stations.

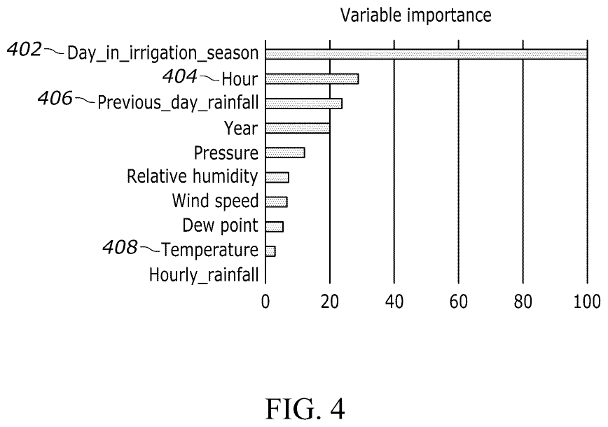

FIG. 4 shows a plurality of features or variables in order of importance used by the random forest algorithm of FIG. 3 in accordance with some embodiments. In some embodiments, the trained machine learning model 208 may be trained with a training dataset 302 comprising a plurality of variables ordered by importance. For example, the time of use (e.g., hour 404 and/or day in irrigation season 402) and/or the amount of previous accumulated precipitation (e.g., previous day rainfall 406) are ordered in higher importance relative to the temperature 408.

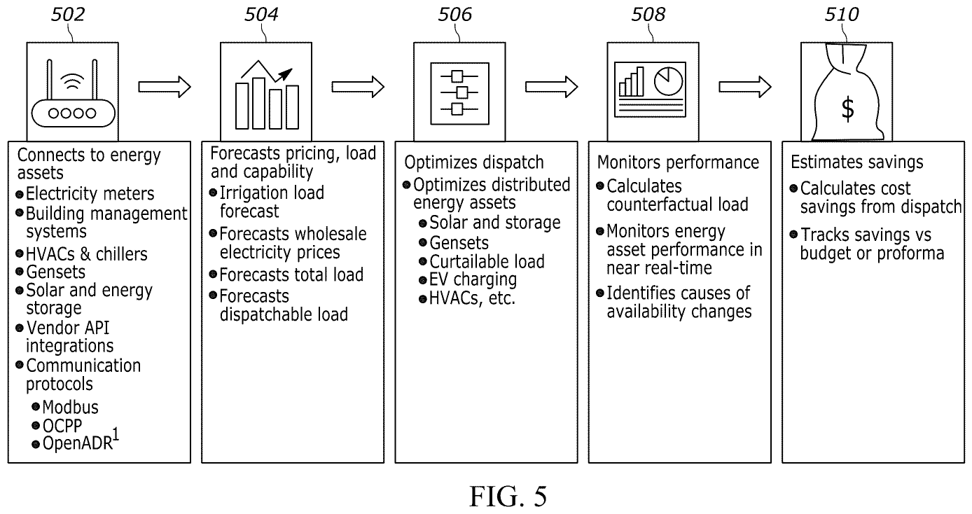

FIG. 5 is a simplified block diagram of an exemplary load shedding use case of forecasting electrical load in irrigation in accordance with some embodiments. In some embodiments, the system 200 shown in FIG. 2 may, at 502, connect and/or receive data from a plurality of energy using devices (e.g., via electricity meters, via building management systems, HVACs & chillers, gensets, solar and energy storage, via vendor API integration, and/or via communication protocols, to name a few). Alternatively or in addition, the system 200 may, at 504, forecast pricing and electrical load and capability for use by a power distributor 108 (e.g., irrigation electrical load forecast, forecasts wholesale electricity prices, forecasts total load, and/or forecasts dispatchable load). Alternatively or in addition, the system 200 may, at 506, optimize dispatch of power sources 102 (e.g., optimizes distributed energy assets, such as solar and storage, gensets, curtailable load, electric vehicle (EV) charging, and/or HVACs, to name a few). Alternatively or in addition, the system 200 may, at 508, monitor performance of the trained machine learning model 208 (e.g., calculates counterfactual load, monitors energy asset performance in near real-time, and/or identifies causes of availability changes). Alternatively or in addition, the system 200 may, at 510, estimate savings from forecasting electrical load needs for a region (e.g., calculates cost savings from dispatch and/or tracks savings vs budget or proforma).

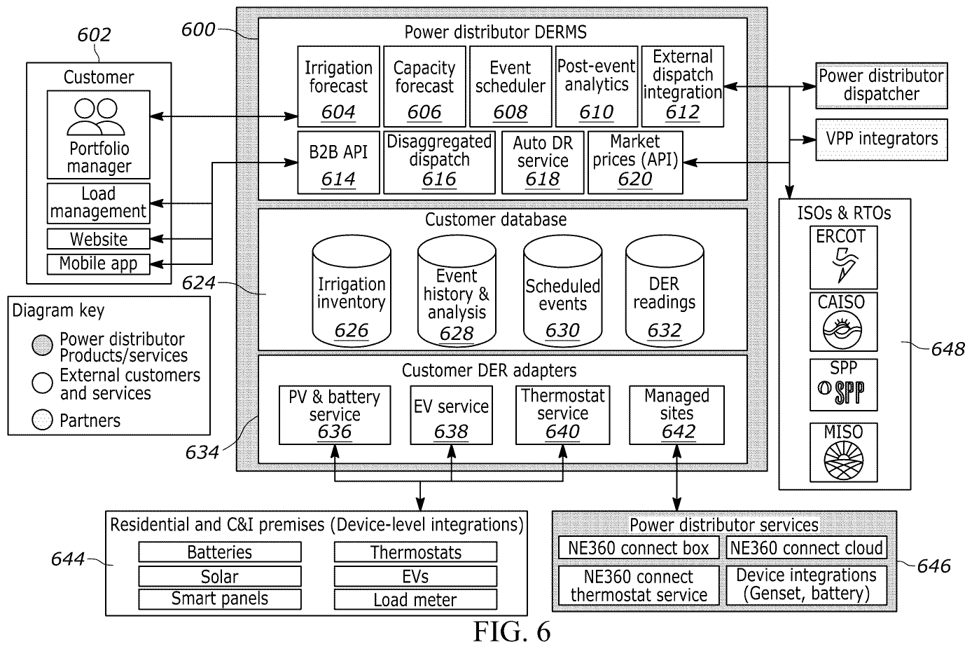

FIG. 6 is a simplified functional block diagram of one embodiment of the system of FIG. 2 in accordance with some embodiments. In some embodiments, the power distribution system 600 (e.g., distributed energy resources management system, DERMS) may execute (e.g., using the first control circuit 204) a plurality of functional features such as irrigation forecast feature 604, capacity forecast feature 606, event scheduler feature 608, post-event analytics feature 610, external dispatch integration feature 612, business-to-business (B2B) application programming interface (API) feature 614, disaggregated dispatch feature 616, auto DR service feature 618, and/or market prices (API) feature 620. For example, the trained machine learning model 208 may execute the irrigation forecast feature 604 to determine a day-ahead forecast of electrical load needed for the irrigation in a region using a random forest algorithm. Alternatively or in addition, the B2B API 614 may be configured to communicatively couple to one or more customer user interface applications 602 (e.g., load management, website, and/or mobile application) operable on one or more electronic devices associated with the customer. In some embodiments, a user interface application (such as user interface 228) may present an adjustment to the customer or user. For example, the adjustment may cause a change in an electrical load usage for a property in the region associated with the day-ahead forecast. In some embodiments, the API feature 620 may communicatively couple to one or more ISOs and RTOs 648 (Independent Sales Organizations and Regional Transmission Organizations). Alternatively or in addition, the power distribution system 600 may communicatively couple to one or more customer databases 624 (e.g., irrigation inventory 626, event history & analysis 628, scheduled events 630 and/or DER readings 632, to name a few). Alternatively or in addition, the system 600 may communicatively couple to or one more customer distributed energy resource (DER) adapters 634 (e.g., PV & battery service 636, EV service 638, thermostat service 640, and/or managed sites 642, to name a few). In some embodiments, the one more customer DER adapters 634 are coupled to one or more residential and commercial and industrial (C&I) premises 644 and/or one or more managed sites 646.

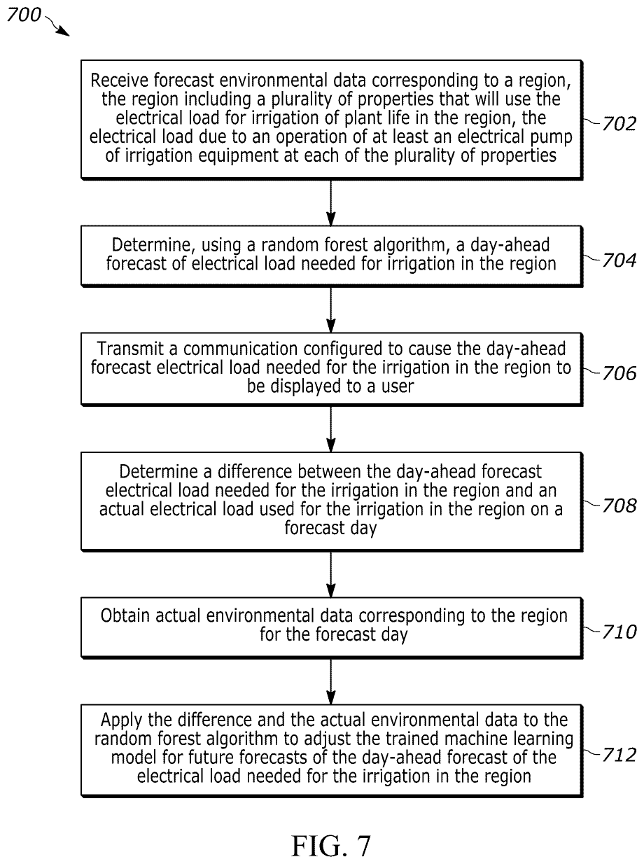

FIG. 7 shows a flow diagram of an exemplary method 700 for use in forecasting electrical load needed for a region in accordance with some embodiments. The process of FIG. 7 may be performed in whole or in part by any of the example systems and devices described herein and/or other systems and devices. In some embodiments, a method 700 for use in forecasting electrical load needs including electrical irrigation needs for a region includes, at step 702, receiving, by a trained machine learning model (e.g., trained machine learning model 208) stored on a non-transitory storage medium and executed by a first control circuit (e.g., first control circuit 204), forecast environmental data corresponding to the region. The region may include a plurality of properties that will use the electrical load for irrigation of plant life in the region. In some embodiments, the electrical load may be due to an operation of at least an electrical pump (e.g., a pump 234) at each of the plurality of properties. In some embodiments, the trained machine learning model is trained using historical environmental data and historical irrigation load data. Alternatively or in addition, the method 700 may, at step 704, include determining, using the trained machine learning model executing a random forest algorithm, a day-ahead forecast of electrical load needed for irrigation in the region. In some embodiments, the machine learning model uses a random forest-based model; however, it is understood that in some embodiments, other types of machine learning models may be used. Alternatively or in addition, the method 700 may, at step 706, include transmitting a communication configured to cause the day-ahead forecast electrical load needed for the irrigation in the region to be displayed to a user.

Alternatively or in addition, the method 700 may, at step 708, include determining a difference between the day-ahead forecast electrical load needed for the irrigation in the region and an actual electrical load used for the irrigation in the region on a forecast day. Alternatively or in addition, the method 700 may, at step 710, include obtaining, by the trained machine learning model, actual environmental data corresponding to the region for the forecast day. Alternatively or in addition, the method 700 may, at step 712, include applying, by the trained machine learning model, the difference and the actual environmental data to the random forest algorithm to adjust the trained machine learning model for future forecasts of the day-ahead forecast of the electrical load needed for the irrigation in the region.

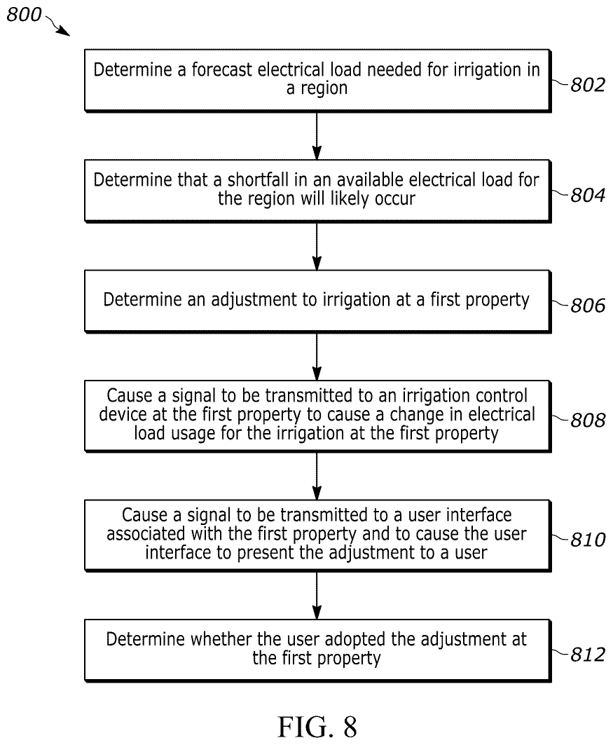

FIG. 8 shows a flow diagram of an exemplary method 800 for energy management in accordance with some embodiments. The process of FIG. 8 may be performed in whole or in part by any of the example systems and devices described herein and/or other systems and devices. In some embodiments, a method 800 includes, at step 802, determining, by a first control circuit (e.g., the first control circuit 204) using a trained machine learning model, a forecast electrical load needed for irrigation in a region. The region may include a plurality of properties that will use electrical load for irrigation of plant life in the region. In some embodiments, the electrical load may be due to the operation of at least an electrical pump. The method 800 may include, step 804, determining, by a second control circuit (e.g., the second control circuit 220), that a shortfall in an available electrical load for the region will likely occur. Alternatively or in addition, the method 800 may include, step 806, determining, by the second control circuit for a first property, an adjustment to irrigation at the first property. Alternatively or in addition, the method 800 may, at step 808, include causing, by the second control circuit in the event the first property has previously opted in to automatic irrigation adjustments, a signal to be transmitted to an irrigation control device at the first property to cause a change in electrical load usage for the irrigation at the first property. Alternatively or in addition, the method 800 may include, at step 810, causing, by the second control circuit in the event the first property has not previously opted in to automatic irrigation adjustments, a signal to be transmitted to a user interface associated with the first property and to cause the user interface to present the adjustment to a user. In some embodiments, the adjustment will cause the change in electrical load usage for the irrigation at the first property if adopted. Alternatively or in addition, the method 800 may, at step 812, include determining, by the second control circuit, whether the user adopted the adjustment at the first property.

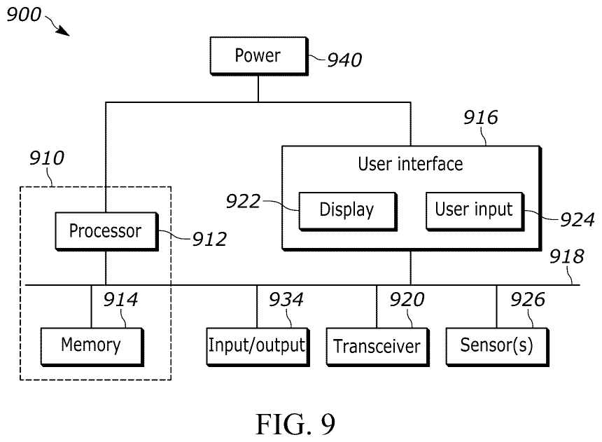

Further, the circuits, circuitry, systems, devices, processes, methods, techniques, functionality, services, servers, sources and the like described herein may be utilized, implemented and/or run on many different types of devices and/or systems. FIG. 9 illustrates an exemplary system 900 that may be used for implementing any of the components, circuits, circuitry, systems, functionality, apparatuses, processes, or devices of the system 200 of FIG. 2, the method 700 of FIG. 7, the method 800 of FIG. 8, and/or other above or below mentioned systems or devices, or parts of such circuits, circuitry, functionality, systems, apparatuses, processes, or devices. For example, the system 900 may be used to implement some or all of the system for use in forecasting electrical load needed for a region, the first control circuit 204, the second control circuit 220, the non-transitory storage medium 206, the irrigation controller 226, the user interface 212, 228, and/or other such components, circuitry, functionality and/or devices. However, the use of the system 900 or any portion thereof is certainly not required.

By way of example, the system 900 may comprise a processor module (or a control circuit) 912, memory 914, and one or more communication links 918, paths, buses or the like. Some embodiments may include one or more user interfaces 916, and/or one or more internal and/or external power sources or supplies 940. The control circuit 912 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 912 can be part of control circuitry and/or a control system 910, which may be implemented through one or more processors with access to one or more memory 914 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 900 may be used to implement one or more of the above or below, or parts of, components, circuits, systems, processes and the like. For example, the system 900 may implement the system for use in forecasting electrical load needed for a region with the first control circuit 204 and/or the second control circuit 220 being the control circuit 912.

The user interface 916 can allow a user to interact with the system 900 and receive information through the system. In some instances, the user interface 916 includes a display 922 and/or one or more user inputs 924, such as buttons, touch screen, track ball, keyboard, mouse, etc., which can be part of or wired or wirelessly coupled with the system 900. Typically, the system 900 further includes one or more communication interfaces, ports, transceivers 920 and the like allowing the system 900 to communicate over a communication bus, a distributed computer and/or communication network (e.g., a local area network (LAN), the Internet, wide area network (WAN), etc.), communication link 918, other networks or communication channels with other devices and/or other such communications or combination of two or more of such communication methods. Further the transceiver 920 can be configured for wired, wireless, optical, fiber optical cable, satellite, or other such communication configurations or combinations of two or more of such communications. Some embodiments include one or more input/output (I/O) interface 934 that allow one or more devices to couple with the system 900. The I/O interface can be substantially any relevant port or combinations of ports, such as but not limited to USB, Ethernet, or other such ports. The I/O interface 934 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 926 to provide information to the system and/or sensor information that is communicated to another component, such as the first control circuit 204, the second control circuit 220, the non-transitory storage medium 206, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 900 comprises an example of a control and/or processor-based system with the control circuit 912. Again, the control circuit 912 can be implemented through one or more processors, controllers, central processing units, logic, software and the like. Further, in some implementations the control circuit 912 may provide multiprocessor functionality.

The memory 914, which can be accessed by the control circuit 912, typically includes one or more processor readable and/or computer readable media accessed by at least the control circuit 912, and can include volatile and/or nonvolatile media, such as RAM, ROM, EEPROM, flash memory and/or other memory technology. Further, the memory 914 is shown as internal to the control system 910; however, the memory 914 can be internal, external or a combination of internal and external memory. Similarly, some or all of the memory 914 can be internal, external or a combination of internal and external memory of the control circuit 912. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 914 can store code, software, executables, scripts, data, content, lists, programming, programs, log or history data, user information, customer information, product information, and the like. While FIG. 9 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for use in forecasting electrical load needs including electrical irrigation needs for a region, the system comprising:
a computer comprising a control circuit and a communication circuit; and
a trained machine learning model stored on a non-transitory storage medium and executable by the control circuit, the trained machine learning model is trained using historical environmental data and historical irrigation load data, and wherein when executed, the trained machine learning model is configured to:
receive, via the communication circuit, forecast environmental data corresponding to the region, the region including a plurality of properties that will use electrical load for irrigation of plant life in the region, the electrical load due to an operation of at least an electrical pump of irrigation equipment at each of the plurality of properties;
determine, using a random forest algorithm, a day-ahead forecast electrical load needed for the irrigation in the region;
transmit a communication, the communication configured to cause the day-ahead forecast electrical load needed for the irrigation in the region to be displayed to a user;
determine a difference between the day-ahead forecast electrical load needed for the irrigation in the region and an actual electrical load used for the irrigation in the region on a forecast day;
obtain actual environmental data corresponding to the region for the forecast day; and
apply the difference and the actual environmental data to the random forest algorithm to adjust the trained machine learning model for future forecasts of the day-ahead forecast electrical load needed for the irrigation in the region.

2. The system of claim 1, wherein the control circuit is configured to execute the adjusted trained machine learning model to determine, using the random forest algorithm, a subsequent day-ahead forecast electrical load needed for irrigation in the region.

3. The system of claim 1, wherein the trained machine learning model is configured to:
automatically determine to be retrained with new data when the difference between the day-ahead forecast of the electrical load needed for the irrigation in the region and the actual electrical load used for irrigation in the region on the forecast day is continuously greater than a threshold over a period of time.

4. The system of claim 1, wherein the forecast environmental data comprises one or more of evapotranspiration, temperature, rainfall, atmospheric pressure, relative humidity, wind speed, dew point, and temperature.

5. The system of claim 1, wherein the trained machine learning model is trained with a training dataset comprising a plurality of variables ordered by importance.

6. The system of claim 1, further comprising a second control circuit configured to:
determine that a shortfall in an available electrical load for the region will likely occur;
determine, for a first property of the plurality of properties, an adjustment to irrigation at the first property;
cause, in an event a user associated with the first property has previously opted in to automatic irrigation adjustments, a control signal to be transmitted via the communication circuit to an irrigation control device at the first property to automatically cause a change in electrical load usage for the irrigation at the first property;
cause, in an event the first property has not previously opted in to the automatic irrigation adjustments, a control signal to be transmitted via the communication circuit to a user interface of the user associated with the first property and to automatically cause the user interface to present the adjustment to the user, wherein the adjustment will cause the change in the electrical load usage for the irrigation at the first property if adopted; and
determine whether the user adopted the adjustment at the first property.

7. The system of claim 6, wherein the irrigation control device comprises at least one of an irrigation controller, an electrical pump, and a water valve.

8. The system of claim 6, wherein the user interface is generated on a display of a mobile handheld electronic device.

9. The system of claim 1, further comprising a second control circuit configured to:
determine, in an event a shortfall in an available electrical load for the region will likely occur, an adjustment to irrigation at a first property; and
cause a control signal to be transmitted to an irrigation control device at the first property to automatically cause a change in electrical load usage for the irrigation at the first property.

10. The system of claim 9, wherein the change in the electrical load usage comprises a change in an irrigation schedule of the first property, an interruption of the irrigation schedule of the first property, and/or a removal of electrical power to the irrigation control device of the first property.

11. The system of claim 1, further comprising a second control circuit configured to:
determine, in an event a shortfall in an available electrical load for the region will likely occur, an adjustment to irrigation at a first property; and
cause, in an event the first property has not previously opted in to automatic irrigation adjustments, a control signal to be transmitted to a user interface associated with the first property and to cause the user interface to automatically present the adjustment to a user, wherein the adjustment will automatically cause a change in electrical load usage for the irrigation at the first property if adopted.

12. A method for use in forecasting electrical load needs including electrical irrigation needs for a region, the method comprising:
receiving, via a communication circuit by a trained machine learning model stored on a non-transitory storage medium and executable by a control circuit, forecast environmental data corresponding to a region, the region including a plurality of properties that will use electrical load for irrigation of plant life in the region, the electrical load due to an operation of at least an electrical pump of irrigation equipment at each of the plurality of properties, wherein a computer includes the control circuit and the communication circuit, and wherein the trained machine learning model is trained using historical environmental data and historical irrigation load data;
determining, using a random forest algorithm, a day-ahead forecast electrical load needed for the irrigation in the region;
transmitting a communication, the communication configured to cause the day-ahead forecast electrical load needed for the irrigation in the region to be displayed to a user;
determining a difference between the day-ahead forecast electrical load needed for the irrigation in the region and an actual electrical load used for the irrigation in the region on a forecast day;
obtaining actual environmental data corresponding to the region for the forecast day; and
applying the difference and the actual environmental data to the random forest algorithm to adjust the trained machine learning model for future forecasts of the day-ahead forecast electrical load needed for the irrigation in the region.

13. The method of claim 12, further comprising executing, by the control circuit, the adjusted trained machine learning model to determine, using the random forest algorithm, a subsequent day-ahead forecast of electrical load needed for irrigation in the region.

14. The method of claim 12, further comprising automatically determining, by the trained machine learning model, to be retrained with new data when the difference between the day-ahead forecast of the electrical load needed for the irrigation in the region and the actual electrical load used for irrigation in the region on the forecast day is continuously greater than a threshold over a period of time.

15. The method of claim 12, wherein the forecast environmental data comprises one or more of evapotranspiration, temperature, rainfall, atmospheric pressure, relative humidity, wind speed, dew point, and temperature.

16. The method of claim 12, further comprising:
determining, by a second control circuit, that a shortfall in an available electrical load for the region will likely occur;
determining, for a first property and by the second control circuit, an adjustment to irrigation at the first property;
causing, in an event the first property has previously opted in to automatic irrigation adjustments and by the second control circuit, a control signal to be transmitted to an irrigation control device at the first property to cause a change in electrical load usage for the irrigation at the first property;
causing, in an event the first property has not previously opted in to the automatic irrigation adjustments and by the second control circuit, a control signal to be transmitted to a user interface associated with the first property and to cause the user interface to present the adjustment to the user, wherein the adjustment will cause the change in the electrical load usage for the irrigation at the first property if adopted; and
determining, by the second control circuit, whether the user adopted the adjustment at the first property, wherein the irrigation control device comprises at least one of an irrigation controller, an electrical pump, and a water valve.

17. The method of claim 12, further comprising:
determining, in an event a shortfall in an available electrical load for the region will likely occur and by a second control circuit, an adjustment to irrigation at a first property; and
causing, by the second control circuit, a control signal to be transmitted to an irrigation control device at the first property to cause a change in electrical load usage for the irrigation at the first property, wherein the change in the electrical load usage comprises a change in an irrigation schedule of the first property, an interruption of the irrigation schedule of the first property, and/or a removal of electrical power to the irrigation control device of the first property.

18. The method of claim 12, further comprising configured to:
determining, in an event a shortfall in an available electrical load for the region will likely occur and by a second control circuit, an adjustment to irrigation at a first property; and
causing, in an event the first property has not previously opted in to automatic irrigation adjustments and by the second control circuit, a control signal to be transmitted to a user interface associated with the first property and to cause the user interface to present the adjustment to a user, wherein the adjustment will cause a change in electrical load usage for the irrigation at the first property if adopted.

19. A system for energy management comprising:
a first control circuit configured to:
determine, using a trained machine learning model, a forecast of electrical load needed for irrigation in a region, the region including a plurality of properties that will use electrical load for irrigation of plant life in the region, the electrical load due to the operation of at least an electrical pump;
a second control circuit configured to:
determine that a shortfall in an available electrical load for the region will likely occur;
determine, for a first property, an adjustment to irrigation at the first property;
cause, in the event the first property has previously opted in to automatic irrigation adjustments, a signal to be transmitted to an irrigation control device at the first property to cause a change in electrical load usage for the irrigation at the first property;
cause, in the event the first property has not previously opted in to automatic irrigation adjustments, a signal to be transmitted to a user interface associated with the first property and to cause the user interface to present the adjustment to a user, wherein the adjustment will cause the change in electrical load usage for the irrigation at the first property if adopted; and
determine whether the user adopted the adjustment at the first property.

20. The system of claim 19, wherein the change in the electrical load usage comprises a change in an irrigation schedule of the first property, an interruption of the irrigation schedule of the first property, and/or a removal of electrical power to the irrigation control device of the first property.
